(19) United States
(12) Patent Application Publication
(10) Pub. No.: US 2024/0200543 A1
(43) Pub. Date: Jun. 20, 2024

(54) CRYOPUMP, METHOD OF MANUFACTURING CRYOPUMP, AND METHOD OF USING CRYOPUMP

(71) Applicant: SUMITOMO HEAVY INDUSTRIES, LTD., Tokyo (JP)

(72) Inventor: Takahiro NAKANISHI, Tokyo (JP)

(21) Appl. No.: 18/537,971

(22) Filed: Dec. 13, 2023

(30) Foreign Application Priority Data
Dec. 14, 2022 (JP) 2022-199652

(51) Int. Cl. F04B 37/08

(52) U.S. Cl. CPC F04B 37/08

(57) ABSTRACT

A cryopump includes: a cryopump vacuum chamber; a cryocooler; a vibration-proof structure that connects the cryocooler to the cryopump vacuum chamber; and a removable restraint that connects the cryocooler to the cryopump vacuum chamber in parallel to the vibration-proof structure and restrains both of expansion and contraction of the vibration-proof structure between the cryocooler and the cryopump vacuum chamber.

### CROSS-REFERENCE TO RELATED APPLICATIONS

This application claims priority to Japanese Patent Application No. 2022-199652, filed on Dec. 14, 2022, which is incorporated by reference herein in its entirety.

### BACKGROUND

### Technical Field

Certain embodiments of the present invention relate to a cryopump, a method of manufacturing a cryopump, and a method of using a cryopump.

### Description of Related Art

A cryopump is a vacuum pump that traps gas molecules through condensation and adsorption on a cryopanel cooled to a cryogenic temperature and exhausts the gas molecules. For example, the cryopump is provided in a vacuum processing device that performs a vacuum process such as a semiconductor circuit manufacturing process and provides a vacuum environment.

The cryopump includes: a cryocooler; and a cryopump vacuum chamber that is attached to the vacuum processing device and supports the cryocooler. The cryopanel is accommodated in the cryopump vacuum chamber and is cooled by the cryocooler. The cryocooler is configured such that an internal pressure of refrigerant gas periodically fluctuates, and this pressure fluctuation may vibrate the cryocooler. In addition, for example, as in a Gifford-McMahon (GM) cryocooler, when a movable member such as a displacer and a drive source for the movable member are incorporated, the movable member and the drive source also vibrate the cryocooler. The vibration generated from the cryocooler may be transmitted to the vacuum processing device through the cryopump vacuum chamber. The vibration may be one factor that may affect the quality of the vacuum process. Therefore, in order to suppress the transmission of the vibration generated from the cryocooler, the related art discloses that a cryocooler is connected to a cryopump vacuum chamber through a vibration-proof structure.

### SUMMARY

According to one embodiment of the present invention, there is provided a cryopump including: a cryopump vacuum chamber; a cryocooler; a vibration-proof structure that connects the cryocooler to the cryopump vacuum chamber; and a removable restraint that connects the cryocooler to the cryopump vacuum chamber in parallel to the vibration-proof structure and restrains both of expansion and contraction of the vibration-proof structure between the cryocooler and the cryopump vacuum chamber.

According to another embodiment of the present invention, there is provided a cryopump including: a cryocooler; a cryopump vacuum chamber; a vibration-proof structure that connects the cryocooler to the cryopump vacuum chamber; and a first attachment portion and a second attachment portion to which a removable restraint that restrains both of expansion and contraction of the vibration-proof structure between the cryocooler and the cryopump vacuum chamber is attached. A first attachment portion is formed in the cryopump vacuum chamber or in a first end portion of the vibration-proof structure toward the cryopump vacuum chamber. A second attachment portion is formed in the cryocooler or in a second end portion of the vibration-proof structure toward the cryocooler.

According to still another embodiment of the present invention, there is provided a method of manufacturing a restraint-attached cryopump, the method including: preparing a cryopump; and attaching a removable restraint to the cryopump. The cryopump includes a cryocooler, a cryopump vacuum chamber, and a vibration-proof structure that connects the cryocooler to the cryopump vacuum chamber. The removable restraint connects the cryocooler to the cryopump vacuum chamber in parallel to the vibration-proof structure and restrains both of expansion and contraction of the vibration-proof structure between the cryocooler and the cryopump vacuum chamber.

According to still another embodiment of the present invention, there is provided a cryopump including: a method of using a cryopump, the method including: preparing a cryopump to which a removable restraint is attached; and removing the removable restraint from the cryopump. The cryopump includes a cryocooler, a cryopump vacuum chamber, and a vibration-proof structure that connects the cryocooler to the cryopump vacuum chamber. The removable restraint connects the cryocooler to the cryopump vacuum chamber in parallel to the vibration-proof structure and restrains both of expansion and contraction of the vibration-proof structure between the cryocooler and the cryopump vacuum chamber.

### BRIEF DESCRIPTION OF THE DRAWINGS

FIG. 1 is a diagram schematically illustrating a cryopump according to an embodiment.

FIG. 2 is an exploded view schematically illustrating a vibration-proof structure according to the embodiment.

FIG. 3A is a schematic plan view illustrating a vibration-proof structure according to the embodiment when seen from a first flange side, and FIG. 3B is a schematic plan view illustrating the vibration-proof structure according to the embodiment when seen from a second flange side.

FIG. 4A schematically illustrates an A-A cross-section of FIG. 3B, and FIG. 4B schematically illustrates a B-B cross-section of FIG. 3B.

FIG. 5A is a schematic perspective view illustrating a first annular support member according to the embodiment, and FIG. 5B is a schematic perspective view illustrating a second annular support member according to the embodiment.

FIG. 6 is a diagram schematically illustrating a part of the cryopump according to the embodiment.

FIG. 7 is a diagram schematically illustrating a part of the cryopump according to the embodiment.

FIG. 8 is a diagram schematically illustrating a part of the cryopump according to the embodiment.

FIG. 9A is a flowchart illustrating an example of a cryopump manufacturing method according to the embodiment, and FIG. 9B is a flowchart illustrating an example of a cryopump using method according to the embodiment.

### DETAILED DESCRIPTION

The disclosed cryopump with the vibration-proof structure includes, for example, a vibration-proof material such as rubber to suppress transmission of vibration. Therefore, the stiffness of a connecting part including the vibration-proof structure between the cryocooler and the cryopump vacuum chamber may decrease as compared to a cryopump in the related art not including the vibration-proof structure. While the cryopump is being transported, for example, is being transported from a manufacturing facility of the cryopump to a field where the cryopump is actually used, various loads or impacts may act on the cryopump. When the vibration-proof structure is deformed due to the load, a risk of contact between components in the cryopump and, in some cases, damage of the cryopump caused by the deformation is assumed.

It is desirable to protect a cryopump that adopts a vibration-proof structure.

With the present invention, the cryopump that adopts the vibration-proof structure can be protected.

Hereinafter, embodiments for carrying out the present invention will be described in detail with reference to the accompanying drawings. In the description and drawings, the same or equivalent components, members, and processes are denoted by the same reference numerals, and overlapping descriptions are omitted as appropriate. The scales and shapes of the illustrated parts are set for convenience in order to facilitate explanation, and should not be construed in a limited manner unless otherwise specified. The embodiment is an example and does not limit the scope of the present invention. All features and combinations thereof described in the embodiment are not necessarily essential to the invention.

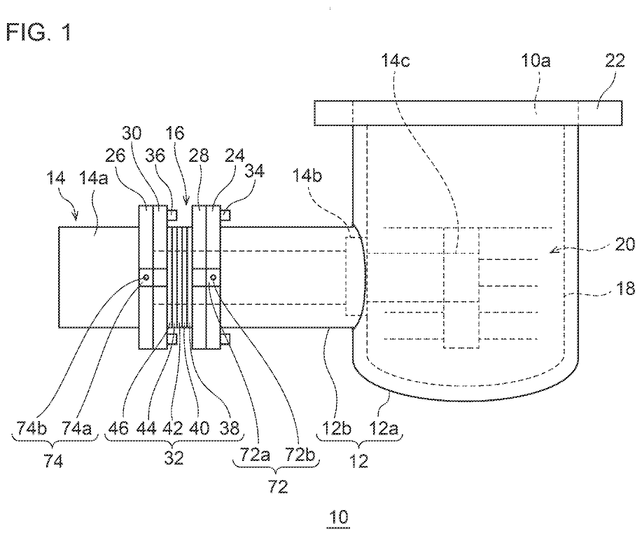

FIG. 1 is a diagram schematically illustrating a cryopump 10 according to an embodiment. The cryopump 10 is attached to, for example, a vacuum chamber of an ion implanter, a sputtering device, a deposition device, or other vacuum processing devices, and is used in order to increase a degree of vacuum inside the vacuum chamber to a level required for a desired vacuum process.

The cryopump 10 includes a cryopump vacuum chamber 12, a cryocooler 14, a vibration-proof structure 16, a first-stage cryopanel 18, and a second-stage cryopanel 20.

Although the details will be described below, the cryocooler 14 is mounted on the cryopump vacuum chamber 12 through the vibration-proof structure 16, and thus the cryopump vacuum chamber 12 is vibration-isolated from the cryocooler 14.

The cryopump vacuum chamber 12 includes a vacuum chamber body 12a that includes an intake port flange 22 and a cryocooler accommodating tube 12b that includes a vacuum chamber flange 24. The vacuum chamber body 12a is a tube (for example, a cylinder) where one end is opened as a cryopump intake port 10a and another end is closed, and the intake port flange 22 is provided in the vacuum chamber body 12a to surround the cryopump intake port 10a. Typically, the intake port flange 22 is mounted on a gate valve. Gas of the vacuum chamber of the vacuum processing device enters the cryopump 10 through the gate valve and the cryopump intake port 10a. The cryopump 10 illustrated in the drawing is a so-called horizontal cryopump. Therefore, the cryocooler accommodating tube 12b is a tube (for example, a cylinder) where opposite ends are opened, one end is joined to a cryocooler insertion hole that is formed in a side surface of the vacuum chamber body 12a, and the vacuum chamber flange 24 is provided at another end.

The cryopump 10 may be a so-called vertical type. In this case, the vacuum chamber body 12a includes the cryocooler insertion hole in a bottom surface instead of the side surface, and the cryocooler accommodating tube 12b is joined to the cryocooler insertion hole in the bottom surface of the vacuum chamber body 12a.

The cryocooler 14 includes a room temperature portion 14a, a first cooling stage 14b, and a second cooling stage 14c, and is inserted into the vacuum chamber body 12a through the vibration-proof structure 16 and the cryocooler accommodating tube 12b. The room temperature portion 14a is positioned outside the cryopump vacuum chamber 12. On the other hand, the first cooling stage 14b and the second cooling stage 14c are positioned in the cryopump vacuum chamber 12. For example, the first cooling stage 14b is positioned in an internal space of the cryocooler accommodating tube 12b, and the second cooling stage 14c is positioned in an internal space of the vacuum chamber body 12a. The first cooling stage 14b may be positioned in the vicinity of a joint portion between the cryocooler accommodating tube 12b and the vacuum chamber body 12a. The cryocooler 14 is, for example, a two-stage GM cryocooler but may be another cryocooler such as a pulse tube cryocooler.

The first-stage cryopanel 18 is thermally coupled to the first cooling stage 14b and is disposed inside the vacuum chamber body 12a. The first-stage cryopanel 18 is structurally supported by the first cooling stage 14b to be in non-contact with the cryopump vacuum chamber 12. The first-stage cryopanel 18 is called a radiation shield and has a tubular shape having a slightly smaller diameter than the vacuum chamber body 12a in most cases. The first-stage cryopanel 18 may be thermally coupled to the radiation shield and may include, for example, the cryopump intake port 10a or a plate-shaped (for example, a disk-shaped) or louver-shaped intake port cryopanel disposed in the vicinity of the cryopump intake port 10a.

The second-stage cryopanel 20 is thermally coupled to the second cooling stage 14c and is disposed inside the vacuum chamber body 12a. The second-stage cryopanel 20 is structurally supported by the second cooling stage 14c to be in non-contact with the first-stage cryopanel 18. The second cooling stage 14c and the second-stage cryopanel 20 are surrounded by the first-stage cryopanel 18.

The disposition or shape of the first-stage cryopanel 18 and the second-stage cryopanel 20 is not limited to the specific shape illustrated in the drawing, and various well-known configurations can be appropriately adopted.

The first-stage cryopanel 18 is cooled to a first cooling temperature by the first cooling stage 14b, and the second-stage cryopanel 20 is cooled to a second cooling temperature by the second cooling stage 14c. The second cooling temperature is lower than the first cooling temperature. The first cooling temperature may be, for example, in a range of about 65 to 120 K or about 80 to 100K. The second cooling temperature may be in a range of about 10 to 20 K.

Accordingly, in the first-stage cryopanel 18, for example, gas (referred to as type 1 gas) such as vapor having a sufficiently low vapor pressure (for example, 10⁻⁸ Pa or lower) at the first cooling temperature is condensed. In the second-stage cryopanel 20, for example, gas (referred to as type 2 gas) such as argon, nitrogen, or oxygen having a sufficiently low vapor pressure at the second cooling temperature is condensed. In the second-stage cryopanel 20, an adsorbent such as activated carbon may be provided. In this case, for example, gas (referred to as type 3 gas) such as hydrogen not having a sufficiently low vapor pressure even at the second cooling temperature is adsorbed on the adsorbent. This way, the cryopump 10 exhausts various gases by condensation or adsorption and can provide a desired vacuum environment.

The room temperature portion 14a of the cryocooler 14 includes a cryocooler flange 26. In a typical cryopump, the cryocooler flange 26 is fastened by the vacuum chamber flange 24, and thus the cryocooler 14 may be attached to the cryopump vacuum chamber 12. However, in the cryopump 10 according to the embodiment, the vibration-proof structure 16 connects the cryocooler flange 26 to the vacuum chamber flange 24. The cryocooler 14 is mounted on the cryopump vacuum chamber 12 through the vibration-proof structure 16. Accordingly, the cryocooler 14 is not directly attached to the cryopump vacuum chamber 12.

The vibration-proof structure 16 includes a first flange 28, a second flange 30, and an annular laminated vibration-proof body 32 that is disposed between the first flange 28 and the second flange 30. The annular laminated vibration-proof body 32 includes a first annular vibration-proof material 38, a first annular support member 40, an intermediate annular vibration-proof material 42, a second annular support member 44, and a second annular vibration-proof material 46.

The first flange 28 is mounted on the vacuum chamber flange 24 and is fixed to the cryopump vacuum chamber 12. For example, the first flange 28 is fastened with the vacuum chamber flange 24 by a plurality of first fastening bolts 34. The second flange 30 is mounted on the cryocooler flange 26, and is fixed to the room temperature portion 14a of the cryocooler 14. For example, the second flange 30 is fastened with the cryocooler flange 26 by a plurality of second fastening bolts 36.

In the example illustrated in the drawing, both of the vacuum chamber flange 24 and the cryocooler flange 26 have an annular shape, and thus the vibration-proof structure 16 also has an annular shape. Note that, when the flange on which the vibration-proof structure 16 is mounted has another shape such as a rectangular shape, the vibration-proof structure 16 may also have another shape such as a square tube shape.

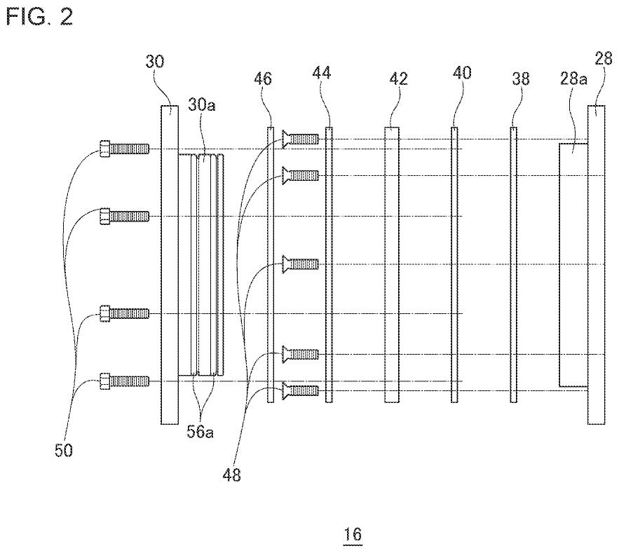

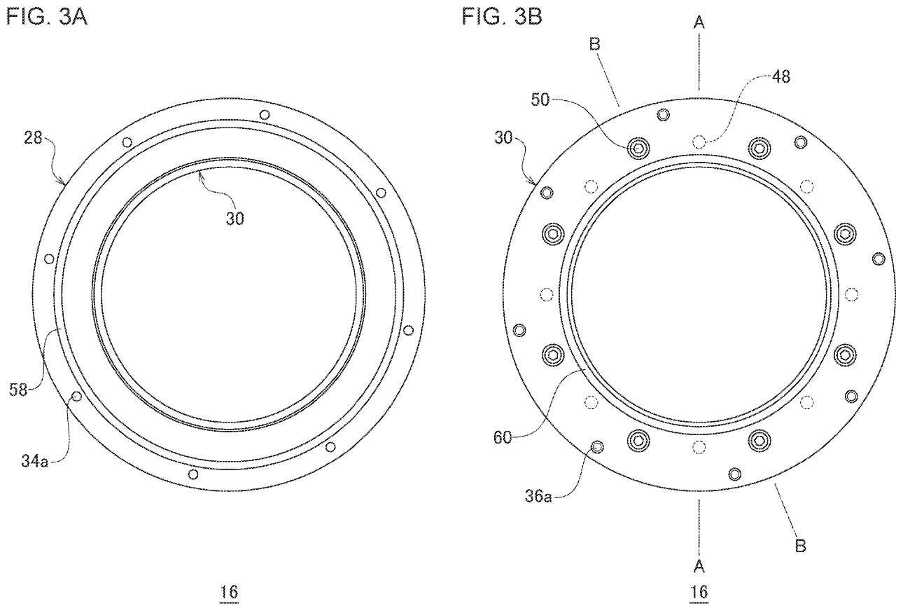

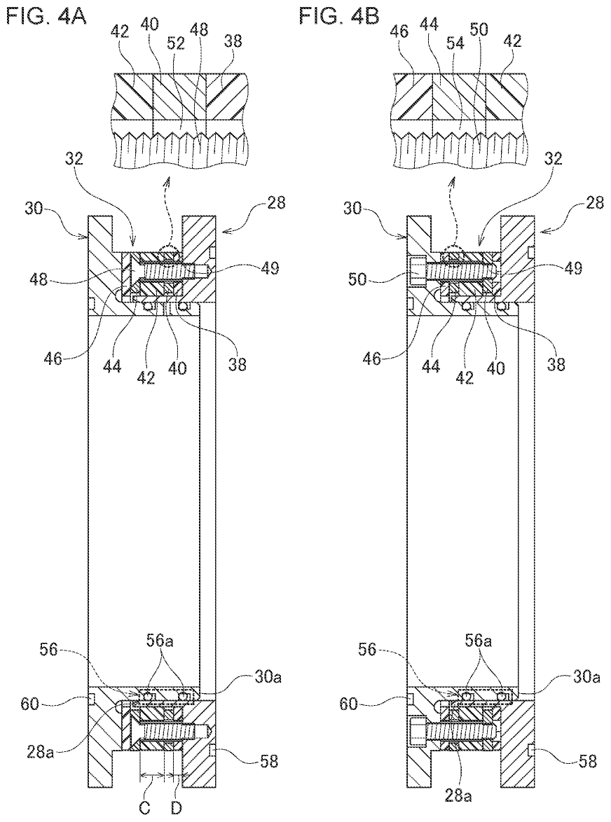

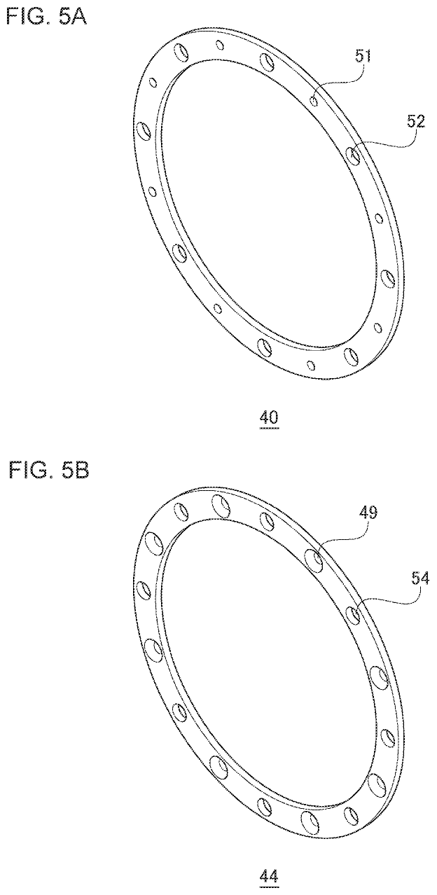

FIG. 2 is an exploded view schematically illustrating the vibration-proof structure 16 according to the embodiment. FIG. 3A is a schematic plan view illustrating the vibration-proof structure 16 according to the embodiment when seen from the first flange 28 side, and FIG. 3B is a schematic plan view illustrating the vibration-proof structure 16 according to the embodiment when seen from the second flange 30 side. FIG. 4A schematically illustrates an A-A cross-section of FIG. 3B, and FIG. 4B schematically illustrates a B-B cross-section of FIG. 3B. In addition, FIG. 5A is a schematic perspective view illustrating the first annular support member 40 according to the embodiment, and FIG. 5B is a schematic perspective view illustrating the second annular support member 44 according to the embodiment.

The first annular vibration-proof material 38, the first annular support member 40, the intermediate annular vibration-proof material 42, the second annular support member 44, and the second annular vibration-proof material 46 are disposed in this order from the first flange 28 toward the second flange 30 to configure the annular lamination vibration-proof body 32.

The components of the annular lamination vibration-proof body 32 have a ring shape and are coaxially disposed adjacent to each other along a center axis direction of the annular lamination vibration-proof body 32. The ring shapes of the respective components may have a common inner diameter and a common outer diameter. The outer diameter of the vibration-proof structure 16 is determined depending on the outer diameters of the first flange 28 and the second flange 30, the outer diameter of the annular lamination vibration-proof body 32 is less than that of the vibration-proof structure 16, and the annular lamination vibration-proof body 32 is confined to a space interposed between the first flange 28 and the second flange 30.

As in the first flange 28 and the second flange 30, the first annular support member 40 and the second annular support member 44 are formed of, for example, a metal material such as stainless steel or another suitable structural material. The first annular vibration-proof material 38, the intermediate annular vibration-proof material 42, and the second annular vibration-proof material 46 are formed of, for example, rubber. Alternatively, the first annular vibration-proof material 38, the intermediate annular vibration-proof material 42, and the second annular vibration-proof material 46 may be formed of, for example, a synthetic resin such as gel or a fluororesin, soft metal such as aluminum, or another vibration-proof material. The first annular vibration-proof material 38, the intermediate annular vibration-proof material 42, and the second annular vibration-proof material 46 may be formed of the same material or may be formed of different materials.

By selecting the materials of the annular vibration-proof materials (38, 42, 46), vibration isolation characteristics (for example, a relationship between a frequency of vibration and a vibration transmissibility) of the vibration-proof structure 16 may be adjusted. By selecting the dimension of the annular vibration-proof material (for example, the thickness of annular lamination vibration-proof body 32 in the center axis direction or the contact area between the adjacent annular support members), the vibration isolation characteristics of the vibration-proof structure 16 may be adjusted. In addition, by selecting the dimensions and/or the materials of the annular support members (40, 44), the vibration isolation characteristics of the vibration-proof structure 16 may be adjusted.

In the vibration-proof structure 16 according to the embodiment, the second annular support member 44 is fixed to the first flange 28 and the first annular support member 40 is fixed to the second flange 30 such that the first flange 28 and the second annular support member 44 are vibration-isolated from the second flange 30 and the first annular support member 40. The vibration-proof structure 16 includes a first fastening member 48 and a second fastening member 50 such that the first flange 28, the second flange 30, and the annular lamination vibration-proof body 32 are fixed to each other.

The first fastening member 48 fixes the second annular support member 44 to the first flange 28 such that the first annular vibration-proof material 38, the first annular support member 40, and the intermediate annular vibration-proof material 42 are interposed and held between the first flange 28 and the second annular support member 44.

The vibration-proof structure 16 includes a first fastening hole 49 that penetrates the second annular support member 44, the intermediate annular vibration-proof material 42, the first annular support member 40, and the first annular vibration-proof material 38 and reaches the first flange 28. The first fastening member 48 is inserted into the first fastening hole 49, and the second annular support member 44 is fastened with the first flange 28 by the first fastening member 48. A fastening force of the first fastening member 48 works on the first annular vibration-proof material 38, the first annular support member 40, and the intermediate annular vibration-proof material 42 interposed between the first flange 28 and the second annular support member 44.

In the example illustrated in the drawing, the first fastening member 48 is a flathead bolt, the first fastening hole 49 is a counterbore in the second annular support member 44, and the head portion of the first fastening member 48 is confined to the second annular support member 44. In addition, the first fastening hole 49 is a bolt hole in the first flange 28, and thus the first fastening member 48 fastens the second annular support member 44 with the first flange 28. The first fastening hole 49 does not penetrate the first flange 28. The first fastening member 48 and the first fastening hole 49 are provided at a plurality of positions (for example, 8 positions) at regular angle intervals in a peripheral direction.

The first fastening member 48 is disposed to be in non-contact with the first annular support member 40. The first annular support member 40 includes a first insertion hole 52 having a larger diameter than the first fastening member 48. The first insertion hole 52 is a so-called unloaded hole that is formed in the first annular support member 40 and is a part of the first fastening hole 49. The first fastening member 48 is inserted into the first insertion hole 52 with a certain play from the first annular support member 40. Accordingly, a vibration transmission channel is not formed between the first fastening member 48 and the first annular support member 40. As in the first insertion hole 52 of the first annular support member 40, an insertion hole into which the first fastening member 48 is inserted is also formed in the first annular vibration-proof material 38 and the intermediate annular vibration-proof material 42. These insertion holes are, for example, circular through-holes but may be through-holes having another shape such as a rectangular shape.

In addition, the first fastening member 48 is disposed to be in non-contact with the second flange 30. The head portion of the first fastening member 48 is supported by the second annular support member 44, and the second annular vibration-proof material 46 is inserted between the second flange 30 and the second annular support member 44. Therefore, the first fastening member 48 is not in contact with the second flange 30.

The second fastening member 50 fixes the first annular support member 40 to the second flange 30 such that the intermediate annular vibration-proof material 42, the second annular support member 44, and the second annular vibration-proof material 46 are interposed and held between the second flange 30 and the first annular support member 40.

The vibration-proof structure 16 includes a second fastening hole 51 that penetrates the second flange 30, the second annular vibration-proof material 46, the second annular support member 44, and the intermediate annular vibration-proof material 42 and reaches the first annular support member 40. The second fastening member 50 is inserted into the second fastening hole 51, and the second flange 30 is fastened with the first annular support member 40 by the second fastening member 50. A fastening force of the second fastening member 50 works on the intermediate annular vibration-proof material 42, the second annular support member 44, the second annular vibration-proof material 46 interposed between the second flange 30 and the first annular support member 40.

In the example illustrated in the drawing, the second fastening member 50 is a bolt, the second fastening hole 51 is a deep counterbore in the second flange 30, and the head portion of the second fastening member 50 is confined to the second flange 30. In addition, the second fastening hole 51 is a bolt hole in the first annular support member 40, and thus the second fastening member 50 fastens the second flange 30 with the first annular support member 40. The second fastening hole 51 penetrates the first annular support member 40. The second fastening member 50 and the second fastening hole 51 are provided at a plurality of positions (for example, 8 positions) at regular angle intervals in the peripheral direction.

The second fastening member 50 is disposed to be in non-contact with the second annular support member 44. The second annular support member 44 includes a second insertion hole 54 having a larger diameter than the second fastening member 50. The second insertion hole 54 is a so-called unloaded hole that is formed in the second annular support member 44 and is a part of the second fastening hole 51. The second fastening member 50 is inserted into the second insertion hole 54 with a certain play from the second annular support member 44. Accordingly, a vibration transmission channel is not formed between the second fastening member 50 and the second annular support member 44. As in the second insertion hole 54 of the second annular support member 44, an insertion hole into which the second fastening member 50 is inserted is also formed in the intermediate annular vibration-proof material 42 and the second annular vibration-proof material 46. These insertion holes are, for example, circular through-holes but may be through-holes having another shape such as a rectangular shape.

The second fastening member 50 is disposed to be in non-contact with the first flange 28. The first annular vibration-proof material 38 is inserted between the first flange 28 and the first annular support member 40. A tip part of the second fastening member 50 does not reach the first flange 28.

A higher axial compressive force than that of the first annular vibration-proof material 38 acts on the intermediate annular vibration-proof material 42. The reason for this is that the first annular vibration-proof material 38 is compressed only with the fastening force of the first fastening member 48; whereas the intermediate annular vibration-proof material 42 is compressed with the fastening forces of both of the first fastening member 48 and the second fastening member 50.

Accordingly, the intermediate annular vibration-proof material 42 is thicker than the first annular vibration-proof material 38 in the center axis direction of the annular lamination vibration-proof body 32. As a result, the strength of the intermediate annular vibration-proof material 42 can be improved. The thickness C of the intermediate annular vibration-proof material 42 may be about 1.5 times to 3 times, for example, about 2 times the thickness D of the first annular vibration-proof material 38. The intermediate annular vibration-proof material 42 may be formed by one material layer having the thickness C. Alternatively, the intermediate annular vibration-proof material 42 may have a structure where a plurality of (for example, two) material layers overlap each other (for example, two material layers that are the same as that used as the first annular vibration-proof material 38 overlap each other). Likewise, a higher axial compressive force than that of the second annular vibration-proof material 46 acts on the intermediate annular vibration-proof material 42. Therefore, the intermediate annular vibration-proof material 42 is thicker than the second annular vibration-proof material 46 in the center axis direction of the annular lamination vibration-proof body 32.

Instead of the circular through-hole, the insertion hole of the annular vibration-proof material may be a cut-out portion (for example, having an U-shape in a plan view) that is connected to an outer periphery (or an inner periphery) of the annular vibration-proof material. The annular vibration-proof material is formed of a soft material such as rubber. Therefore, this cut-out portion may be processed more easily than the through-hole. Likewise, the insertion hole of the annular support member may also be a cut-out portion that is connected to an outer periphery (or an inner periphery) of the annular support member.

The first fastening member 48 and the second fastening member 50 (that is, the first fastening hole 49 and the second fastening hole 51) are disposed at positions that are the same in the radial direction of the annular lamination vibration-proof body 32 and are different in the peripheral direction. Note that, for example, by disposing the first fastening member 48 and the second fastening member 50 at positions that are different in the radial direction, the first fastening member 48 and the second fastening member 50 can be disposed at positions that are the same in the peripheral direction of the annular lamination vibration-proof body 32.

The second flange 30 is airtightly connected to the first flange 28. A vacuum seal portion 56 is formed between the first flange 28 and the second flange 30. The first flange 28 includes a first flange tubular portion 28a extending from an opening portion toward the second flange 30, and the second flange 30 includes a second flange tubular portion 30a extending from an opening portion toward the first flange 28.

The outer diameter of the second flange tubular portion 30a is slightly less than the inner diameter of the first flange tubular portion 28a, and the second flange tubular portion 30a is inserted into the first flange tubular portion 28a. For example, a sealing member 56a such as an 0-ring is disposed between an inner peripheral surface of the first flange tubular portion 28a and an outer peripheral surface of the second flange tubular portion 30a, and thus the vacuum seal portion 56 is formed. The sealing member 56a is mounted on the outer peripheral surface of the second flange tubular portion 30a.

In the vacuum seal portion 56, a dimensional tolerance between the first flange tubular portion 28a and the second flange tubular portion 30a is determined such that the first flange tubular portion 28a and the second flange tubular portion 30a are in contact with each other through only the sealing member 56a. Accordingly, a gap of 0.05 to 0.3 mm, for example, 0.1 mm is formed between the inner peripheral surface of the first flange tubular portion 28a and the outer peripheral surface of the second flange tubular portion 30a, and the first flange 28 and the second flange 30 are not in contact with each other.

A positional relationship in the radial direction between the first flange tubular portion 28a and the second flange tubular portion 30a can also be reversed, and the first flange tubular portion 28a may be inserted into the second flange tubular portion 30a, and the vacuum seal portion 56 may be formed between the outer peripheral surface of the first flange tubular portion 28a and the inner peripheral surface of the second flange tubular portion 30a.

The first flange 28 is a vacuum flange that is airtightly connected to the vacuum chamber flange 24, and a first ring groove 58 that accommodates a sealing member such as an O-ring is formed in a flange end surface. The first ring groove 58 is positioned inside a first bolt hole 34a for the first fastening bolts 34 in the radial direction and is positioned outside the first fastening member 48 in the radial direction. In addition, the second flange 30 is a vacuum flange that is airtightly connected to the cryocooler flange 26, and a second ring groove 60 that accommodates a sealing member such as an O-ring is formed in a flange end surface. The second ring groove 60 is positioned inside the second fastening member 50 in the radial direction. A second bolt hole 36a for the second fastening bolt 36 is formed outside the second fastening member 50 in the radial direction.

The annular lamination vibration-proof body 32 is disposed outside the vacuum seal portion 56 in the radial direction. The annular lamination vibration-proof body 32 is disposed outside a vacuum environment to surround the first flange tubular portion 28a and the second flange tubular portion 30a. That is, the annular lamination vibration-proof body 32 is disposed in the surrounding environment as in the room temperature portion 14a of the cryocooler 14. As a result, as compared to a case where the annular lamination vibration-proof body 32 is disposed in a vacuum environment, the diameters of the vacuum seal portion 56 and the vacuum flange can be easily designed to be small. In addition, the diameter of the annular lamination vibration-proof body 32 can be easily designed to be large. In this case, due to an increase in the area of the annular vibration-proof material, the spring constant of the vibration-proof structure 16 is likely to be reduced, and the vibration transmissibility of a high frequency is likely to be reduced.

An example of an assembly procedure of the vibration-proof structure 16 will be described. First, the first flange 28 is placed such that the first flange tubular portion 28a faces upward. The first annular vibration-proof material 38, the first annular support member 40, the intermediate annular vibration-proof material 42, and the second annular support member 44 are laminated in this order on the first flange 28. These members are laminated on the first flange 28 such that the positions of the through-holes of the members match with each other, and thus the first fastening hole 49 is formed. The first fastening member 48 is inserted into the first fastening hole 49, and the second annular support member 44 is fastened with the first flange 28.

Next, the second annular vibration-proof material 46 is laminated on the second annular support member 44, and the second flange 30 is attached thereto. In this case, the second flange tubular portion 30a is inserted into the first flange tubular portion 28a. In addition, by allowing the positions of the through-holes of the members to match with each other, the second fastening hole 51 is formed. The second fastening member 50 is inserted into the second fastening hole 51, and the second flange 30 is fastened with the first annular support member 40. This way, the vibration-proof structure 16 is assembled.

This way, the first annular support member 40 is interposed between the first annular vibration-proof material 38 and the intermediate annular vibration-proof material 42, and is disposed to be in non-contact with the first flange 28, the second annular support member 44, and the first fastening member 48. The second annular support member 44 is interposed between the second annular vibration-proof material 46 and the intermediate annular vibration-proof material 42, and is disposed to be in non-contact with the second flange 30, the first annular support member 40, and the second fastening member 50. In addition, as described above, the first flange 28 and the second flange 30 are not in direct contact with each other.

Accordingly, the vibration-proof structure 16 includes: a first support structure that includes the first flange 28, the second annular support member 44, and the first fastening member 48; and a second support structure that includes the second flange 30, the first annular support member 40, and the second fastening member 50, in which the first support structure and the second support structure are vibration-isolated from the first annular vibration-proof material 38, the intermediate annular vibration-proof material 42, and the second annular vibration-proof material 46. The first support structure is fixed to the cryopump vacuum chamber 12, and the second support structure is fixed to the cryocooler 14.

In an existing cryopump, in most cases, the cryocooler is directly fixed to the cryopump vacuum chamber. The cryocooler may be a vibration source due to a periodical pressure fluctuation and the movement of a movable member such as a displacer. The vibration of the cryocooler may be transmitted to the cryopump vacuum chamber, and may be further transmitted to the vacuum processing device on which the cryopump is mounted.

On the other hand, in the cryopump 10 according to the embodiment, the cryocooler 14 is mounted on the cryopump vacuum chamber 12 through the vibration-proof structure 16. The vibration-proof structure 16 includes: the first flange 28 that is fixed to the cryopump vacuum chamber 12, the second flange 30 that is fixed to the cryocooler 14, and the annular lamination vibration-proof body 32 where the first annular vibration-proof material 38, the first annular support member 40, the intermediate annular vibration-proof material 42, the second annular support member 44, and the second annular vibration-proof material 46 are disposed in this order from the first flange 28 toward the second flange 30. The second annular support member 44 is fixed to the first flange 28 and the first annular support member 40 is fixed to the second flange 30 such that the first flange 28 and the second annular support member 44 are vibration-isolated from the second flange 30 and the first annular support member 40.

As a result, the cryopump vacuum chamber 12 is vibration-isolated from the cryocooler 14. Accordingly, vibration that is transmitted from the cryocooler 14 to another device can be reduced. The risk of transmission of the vibration of the cryocooler 14 to the vacuum processing device can also be reduced.

In the above-described embodiment, the vacuum seal portion 56 is provided to hold a vacuum environment inside the vibration-proof structure 16. The vacuum seal portion 56 is formed by a fitting structure (a so-called spigot joint structure) between the first flange 28 and the second flange 30 and the sealing member 56a that is mounted between the two flanges. However, another structure that ensures the airtightness of the vibration-proof structure 16 can also be used. For example, the first flange 28 and the second flange 30 may be prepared as an integral structure by bellows connection. In this case, the annular lamination vibration-proof body 32 that is disposed between the first flange 28 and the second flange 30 may have a divided structure configured by a combination of a plurality of portions. The annular lamination vibration-proof body 32 may be divided into a plurality of arc-shaped (for example, two semicircular) lamination vibration-proof bodies, and these divided lamination vibration-proof bodies may be coupled to each other in an annular shape or may be arranged in an annular shape to form the annular lamination vibration-proof body 32.

Incidentally, the vibration-proof structure 16 includes the vibration-proof material such as rubber. Therefore, the stiffness may be relatively low. The stiffness of a connecting part including the vibration-proof structure 16 between the cryocooler 14 and the cryopump vacuum chamber 12 may decrease as compared to a cryopump in the related art not including the vibration-proof structure 16. Therefore, when an unexpected load or impact acts on the cryopump 10, the vibration-proof structure 16 is deformed, and a risk of contact between adjacent components (for example, the cryopump vacuum chamber 12 and the first-stage cryopanel 18) in the cryopump 10 and, in some cases, damage of the cryopump 10 is assumed. This risk is concerned while the cryopump 10 is being transported, for example, is being transported from a manufacturing facility of the cryopump 10 to a field where the cryopump 10 is actually used.

Before the transport, the cryopump 10 may be packaged, for example, with a packaging material such as expanded polystyrene. However, the packaging material that can be inexpensively used has some gap with the cryopump 10. Therefore, due to the impact load or the like during the transport, the vibration-proof structure 16 in the packaging material may be deformed such that the cryocooler 14 moves relative to the cryopump vacuum chamber 12. As a result, as described above, damage may occur in the cryopump 10. According to the consideration by the present inventors, it is difficult for the existing packaging material to effectively suppress the movement of the cryocooler 14 during the contraction as compared to a case where the vibration-proof structure 16 expands. When the dimensional tolerance of the packaging material is strict, a gap between the packaging material and the cryopump 10 may be reduced. This configuration brings about an increase in the manufacturing cost of the packaging material, which is not desirable.

Accordingly, in the embodiment, as described below, a restraint 70 for preventing the deformation of the vibration-proof structure 16 can be attached to the cryopump 10. When the cryopump 10 is not used, for example, when the cryopump 10 is transported or stored, the restraint 70 is attached to the cryopump 10. When the restraint 70 is combined with the vibration-proof structure 16, the deformation of the vibration-proof structure 16 and the movement of the cryocooler 14 on the cryopump vacuum chamber 12 caused by the deformation can be prevented. The restraint 70 is removable from the cryopump 10. When the cryopump 10 is used, that is, when the cryopump 10 is provided in the vacuum processing device and is evacuated, the restraint 70 is removed from the cryopump 10 such that the vibration-proof structure 16 can provide a vibration-proof function.

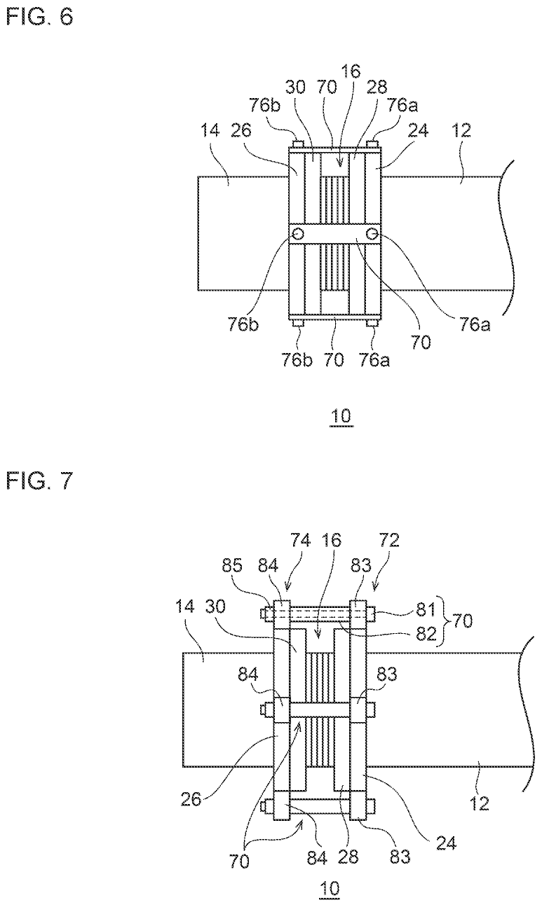

FIG. 6 is a diagram schematically illustrating a part of the cryopump 10 according to the embodiment. FIG. 6 illustrates a state where the removable restraint 70 is attached to the cryopump 10. The restraint 70 connects the cryocooler 14 to the cryopump vacuum chamber 12 in parallel to the vibration-proof structure 16 and restrains both of expansion and contraction of the vibration-proof structure 16 between the cryocooler 14 and the cryopump vacuum chamber 12.

FIG. 1 illustrates the cryopump 10 to which the restraint 70 is not attached. As illustrated in FIG. 1, in the cryopump 10, a first attachment portion 72 that is formed in the cryopump vacuum chamber 12 and a second attachment portion 74 that is formed in the cryocooler 14 are provided. In the embodiment, the first attachment portion 72 is formed in an outer peripheral surface of the vacuum chamber flange 24, and the second attachment portion 74 is formed in an outer peripheral surface of the cryocooler flange 26.

The first attachment portion 72 is formed at a plurality of positions (for example, at least three positions) in the peripheral direction on the outer peripheral surface of the vacuum chamber flange 24. Likewise, the second attachment portion 74 is formed at a plurality of positions (for example, at least three positions) in the peripheral direction on the outer peripheral surface of the cryocooler flange 26. In this example, four first attachment portions 72 are formed at regular intervals in the peripheral direction on the outer peripheral surface of the vacuum chamber flange 24, and four second attachment portions 74 are formed at regular intervals in the peripheral direction on the outer peripheral surface of the cryocooler flange 26. The second attachment portions 74 are formed on the outer peripheral surface of the cryocooler flange 26 in the disposition corresponding to the first attachment portions 72 (that is, at the same positions in the peripheral direction as those of the first attachment portion 72).

The first attachment portion 72 includes: a first seating surface 72a that is formed in the outer peripheral surface of the vacuum chamber flange 24; and a first screw hole 72b (for example, a bolt hole) that is formed in the first seating surface 72a. The first seating surface 72a has a shape corresponding to the shape of the restraint 70. On the outer peripheral surface of the first flange 28 of the vibration-proof structure 16 adjacent to the vacuum chamber flange 24, a seating surface corresponding to the shape of the restraint 70 continued from the first seating surface 72a is also formed. For example, when the restraint 70 is a flat plate as described below, the first seating surface 72a is also a flat surface. The seating surface formed on the first flange 28 is also a flat surface flush with the first seating surface 72a.

As in the first attachment portion 72, the second attachment portion 74 includes: a second seating surface 74a that is formed in the outer peripheral surface of the cryocooler flange 26 to correspond to the shape of the restraint 70; and a second screw hole 74b (for example, a bolt hole) that is formed in the second seating surface 74a. On the outer peripheral surface of the second flange 30 of the vibration-proof structure 16 adjacent to the cryocooler flange 26, a seating surface corresponding to the shape of the restraint 70 continued from the second seating surface 74a is also formed.

The restraint 70 is a plate material or a rod material, for example, an elongated flat plate. Alternatively, the restraint 70 may be a plate having another appropriate shape, for example, an arc-shaped plate having a shape along the flange outer peripheral surface. The restraint 70 is formed of a material having high stiffness, for example, a metal material (for example, stainless steel). This high-stiffness material has a higher Young's modulus than the vibration-proof materials of the vibration-proof structure 16 (for example, the first annular vibration-proof material 38, the intermediate annular vibration-proof material 42, and the second annular vibration-proof material 46 illustrated in FIG. 1). Accordingly, the restraint 70 has a higher Young's modulus in a direction of expansion and contraction of the vibration-proof structure 16 than the vibration-proof structure 16. The restraint 70 may be formed of a synthetic resin material having higher stiffness than the vibration-proof material or another appropriate material.

As illustrated in FIG. 7, the removable restraint 70 includes one end attached to the first attachment portion 72 and another end attached to the second attachment portion 74. In order to attach the restraint 70 to the first attachment portion 72 and the second attachment portion 74, a first attachment member 76a and a second attachment member 76b are used. For example, the first attachment member 76a may be a screw (for example, a bolt) that is screwed to the first screw hole 72b, and the second attachment member 76b may be a screw (for example, a bolt) that is screwed to the second screw hole 74b. At opposite ends of the restraint 70, through holes corresponding to the attachment members are formed.

By bringing one end of the restraint 70 into contact with the first seating surface 72a, inserting the first attachment member 76a into the hole of the one end of the restraint 70, and attaching the first attachment member 76a to the first screw hole 72b, the one end of the restraint 70 is fixed to the first attachment portion 72. Likewise, by bringing another end of the restraint 70 into contact with the second seating surface 74a, inserting the second attachment member 76b into the hole of the other end of the restraint 70, and attaching the second attachment member 76b to the second screw hole 74b, the other end of the restraint 70 is fixed to the second attachment portion 74.

This way, the restraint 70 that is attached to the cryopump 10 extends along the vibration-proof structure 16 from the first attachment portion 72 to the second attachment portion 74 such that opposite ends of the vibration-proof structure 16 are bridged. The restraint 70 is fixed to the vibration-proof structure 16 due to the fastening forces of the first attachment member 76a and the second attachment member 76b. As a result, the restraint 70 can restrain both of expansion and contraction of the vibration-proof structure 16, and can restrain the movement of the cryocooler 14 relative to the cryopump vacuum chamber 12. Accordingly, the risk of the deformation of the vibration-proof structure 16 caused by an unexpected load or impact that may act during the transport of the cryopump 10 and the occurrence of damage in the cryopump 10 caused by the deformation can be reduced, and the cryopump 10 can be protected.

The first attachment portion 72 and the second attachment portion 74 can also adopt another disposition. For example, the first attachment portion 72 may be formed in an end portion of the vibration-proof structure 16 on the cryopump vacuum chamber 12 side, and the second attachment portion 74 may be formed in an end portion of the vibration-proof structure 16 on the cryocooler 14 side. In the above-described embodiment, the first flange 28 of the vibration-proof structure 16 is fixed to the vacuum chamber flange 24, and the second flange 30 of the vibration-proof structure 16 is fixed to the cryocooler flange 26. Accordingly, the first attachment portion 72 may be formed on the outer peripheral surface of the first flange 28 of the vibration-proof structure 16. Likewise, the second attachment portion 74 may be formed on the outer peripheral surface of the second flange 30 of the vibration-proof structure 16.

In addition, the first attachment portion 72 and the second attachment portion 74 can also adopt another shape. For example, these attachment portions may have a protrusion instead of the screw hole. This protrusion may be a male screw (bolt) that is formed in the outer peripheral surface. In this case, the first attachment member 76a and the second attachment member 76b may be corresponding nuts. By inserting the attachment portion (protrusion) into the hole of the end portion of the restraint 70, bringing the restraint 70 into contact with the seating surface of the attachment portion, and attaching the attachment member to the attachment portion, the restraint 70 may be fixed to the attachment portion. Alternatively, the first attachment portion 72 and the second attachment portion 74 may have another shape that engages with the restraint 70 to fix the restraint 70. The restraint 70 may have any shape that is attachable to the attachment portion.

FIG. 7 is a diagram schematically illustrating a part of the cryopump 10 according to the embodiment. FIG. 7 illustrates a state where the removable restraint 70 is attached to the cryopump 10. As in the above-described embodiment, the restraint 70 connects the cryocooler 14 to the cryopump vacuum chamber 12 in parallel to the vibration-proof structure 16 and restrains both of expansion and contraction of the vibration-proof structure 16 between the cryocooler 14 and the cryopump vacuum chamber 12.

In the cryopump 10, the first attachment portion 72 that is formed in the cryopump vacuum chamber 12 and the second attachment portion 74 that is formed in the cryocooler 14 are provided. In the embodiment, the first attachment portion 72 is formed in the vacuum chamber flange 24, and the second attachment portion 74 is formed in the outer peripheral surface of the cryocooler flange 26.

The restraint 70 includes a first restraint member 81 and a second restraint member 82. The first restraint member 81 includes one end attached to the first attachment portion 72 and another end attached to the second attachment portion 74 and restrains expansion of the vibration-proof structure 16. The first restraint member 81 is, for example, rod-like and may be, for example, a bolt. The second restraint member 82 is disposed along the first restraint member 81 between the first attachment portion 72 and the second attachment portion 74 and restrains contraction of the vibration-proof structure 16. For example, the second restraint member 82 may be a tube into which the first restraint member 81 can be inserted. As in the above-described embodiment, the first restraint member 81 and the second restraint member 82 are formed of, for example, the high-stiffness material such as a metal material (for example, stainless steel).

The first attachment portion 72 may include a first edge portion 83 that is formed in the vacuum chamber flange 24, and the second attachment portion 74 may include a second edge portion 84 that is formed in the cryocooler flange 26. The first edge portion 83 is a protrusion that protrudes outward in the radial direction from the outer periphery of the vacuum chamber flange 24, and includes a hole (for example, a bolt through hole) that receives the first restraint member 81. Likewise, the second edge portion 84 is a protrusion that protrudes outward in the radial direction from the outer periphery of the cryocooler flange 26, and includes a hole (for example, a bolt through hole) that receives the first restraint member 81.

The first edge portion 83 is formed at a plurality of positions (for example, at least three positions) in the peripheral direction on the outer peripheral surface of the vacuum chamber flange 24. Likewise, the second edge portion 84 is formed at a plurality of positions (for example, at least three positions) in the peripheral direction on the outer peripheral surface of the cryocooler flange 26. In this example, four first edge portions 83 are formed at regular intervals in the peripheral direction on the outer peripheral surface of the vacuum chamber flange 24, and four second edge portions 84 are formed at regular intervals in the peripheral direction on the outer peripheral surface of the cryocooler flange 26. The second edge portions 84 are formed on the outer peripheral surface of the cryocooler flange 26 in the disposition corresponding to the first edge portions 83 (that is, at the same positions in the peripheral direction as those of the first edge portions 83).

The first attachment portion 72 may be formed in an end portion of the vibration-proof structure 16 on the cryopump vacuum chamber 12 side, and the second attachment portion 74 may be formed in an end portion of the vibration-proof structure 16 on the cryocooler 14 side. In the above-described embodiment, the first flange 28 of the vibration-proof structure 16 is fixed to the vacuum chamber flange 24, and the second flange 30 of the vibration-proof structure 16 is fixed to the cryocooler flange 26. Accordingly, the first edge portion 83 may be formed on the first flange 28 of the vibration-proof structure 16. Likewise, the second edge portion 84 may be formed on the second flange 30 of the vibration-proof structure 16.

The restraint 70 includes one end attached to the first attachment portion 72 and another end attached to the second attachment portion 74. For example, when the first restraint member 81 is a bolt, first, the first restraint member 81 is inserted into the bolt through hole of the first edge portion 83 and the second restraint member 82. In this case, the second restraint member 82 is disposed between the first edge portion 83 and the second edge portion 84, that is, on the opposite side of the bolt head portion of the first restraint member 81 with respect to the first edge portion 83. Next, a tip part of the first restraint member 81 is inserted into the bolt through hole of the second edge portion 84, and the first restraint member 81 is fixed to the second edge portion 84 using a nut 85. In the second edge portion 84, a bolt hole to which the first restraint member 81 is screwed may be formed. In this case, the tip part of the first restraint member 81 is directly fixed to the second edge portion 84. Therefore, the nut 85 does not need to be used.

This way, the restraint 70 that is attached to the cryopump 10 extends along the vibration-proof structure 16 from the first attachment portion 72 to the second attachment portion 74 such that opposite ends of the vibration-proof structure 16 are bridged. The first restraint member 81 engages with the outsides of both of the first edge portion 83 and the second edge portion 84 and can restrain expansion of the vibration-proof structure 16. In addition, the length of the second restraint member 82 in the axial direction is the same as the interval between the first edge portion 83 and the second edge portion 84. The second restraint member 82 is inserted into the first restraint member 81 and is interposed between the first edge portion 83 and the second edge portion 84. Therefore, the contraction of the vibration-proof structure 16 can be restrained.

As a result, the restraint 70 can restrain both of expansion and contraction of the vibration-proof structure 16, and can restrain the movement of the cryocooler 14 relative to the cryopump vacuum chamber 12. The risk of the deformation of the vibration-proof structure 16 caused by an unexpected load or impact that may act during the transport of the cryopump 10 and the occurrence of damage in the cryopump 10 caused by the deformation can be reduced, and the cryopump 10 can be protected.

When a space where the first attachment portion 72 and the second attachment portion 74 are provided is ensured on the vacuum chamber flange 24 and the cryocooler flange 26, the first edge portion 83 and the second edge portion 84 do not need to be provided. In this case, a hole into which the first restraint member 81 is inserted may be provided in the vacuum chamber flange 24 and the cryocooler flange 26.

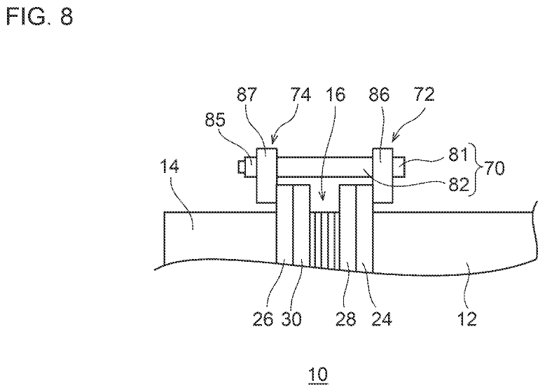

FIG. 8 is a diagram schematically illustrating a part of the cryopump 10 according to the embodiment. The first attachment portion 72 may include a first attachment block 86 instead of the above-described first edge portion 83. The second attachment portion 74 may include a second attachment block 87 instead of the above-described second edge portion 84. The first attachment block 86 is attached to the vacuum chamber flange 24, for example, by an attachment member such as a bolt. In this case, an existing bolt hole that is present on the vacuum chamber flange 24 may be used. In the first attachment block 86, a through hole of the first restraint member 81 is formed as in the first edge portion 83. Likewise, the second attachment block 87 is attached to the cryocooler flange 26, for example, by an attachment member such as a bolt. In this case, an existing bolt hole that is present on the cryocooler flange 26 may be used. In the second attachment block 87, a through hole of the first restraint member 81 is formed as in the second edge portion 84.

The first restraint member 81 is inserted into a through hole of the first attachment block 86 and the second restraint member 82. In this case, the second restraint member 82 is disposed between the first attachment block 86 and the second attachment block 87. Next, the tip part of the first restraint member 81 is inserted into the through hole of the second attachment block 87, and the first restraint member 81 is fixed to the second attachment block 87 using the nut 85. In the second attachment block 87, a bolt hole to which the first restraint member 81 is screwed may be formed. In this case, the tip part of the first restraint member 81 is directly fixed to the second attachment block 87. Therefore, the nut 85 does not need to be used.

Even in the embodiment of FIG. 8, as in the embodiment of FIG. 7, the restraint 70 can restrain both of expansion and contraction of the vibration-proof structure 16, and can restrain the movement of the cryocooler 14 relative to the cryopump vacuum chamber 12. The risk of the deformation of the vibration-proof structure 16 caused by an unexpected load or impact that may act during the transport of the cryopump 10 and the occurrence of damage in the cryopump 10 caused by the deformation can be reduced, and the cryopump 10 can be protected.

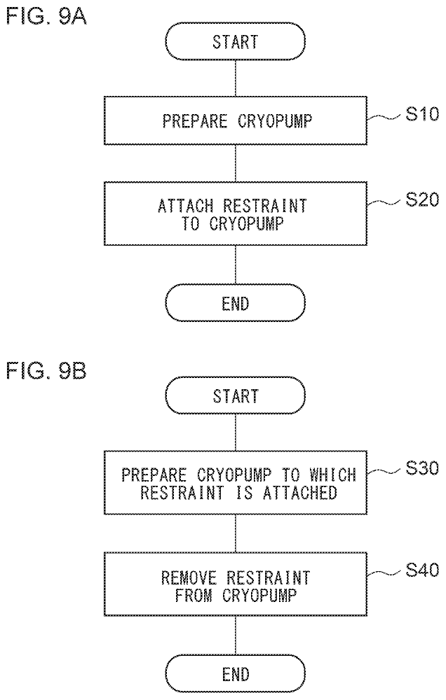

FIG. 9A is a flowchart illustrating an example of a cryopump manufacturing method according to the embodiment, and FIG. 9B is a flowchart illustrating an example of a cryopump using method according to the embodiment.

As illustrated in FIG. 9A, the cryopump manufacturing method includes: preparing the cryopump 10 (S10); and attaching the removable restraint 70 to the cryopump 10 (S20). For example, the cryopump 10 to which the restraint 70 is not attached that is described with reference to FIG. 1 is prepared. For example, as described above with reference to FIGS. 6 to 8, the removable restraint 70 connects the cryocooler 14 to the cryopump vacuum chamber 12 in parallel to the vibration-proof structure 16 and restrains both of expansion and contraction of the vibration-proof structure 16 between the cryocooler 14 and the cryopump vacuum chamber 12. The attachment of the restraint 70 (S20) may be performed, for example, before shipment of the cryopump 10 that is one process of the final stage during the manufacturing of the cryopump 10. This method may further include packaging the cryopump 10 to which the restraint 70 is attached with a packaging material.

With this configuration, the restraint 70 can restrain the movement of the cryocooler 14 relative to the cryopump vacuum chamber 12, the risk of the deformation of the vibration-proof structure 16 caused by an unexpected load or impact and the occurrence of damage in the cryopump 10 caused by the deformation can be reduced, and the cryopump 10 can be protected.

As illustrated in FIG. 9B, the cryopump using method includes: preparing the cryopump 10 to which the removable restraint 70 is attached; (S30); and removing the removable restraint 70 from the cryopump 10 (S40). For example, in the embodiment of FIG. 6, by removing the first attachment member 76a and the second attachment member 76b from the first attachment portion 72 and the second attachment portion 74, respectively, the restraint 70 can be removed from the cryopump 10. In the embodiment of FIGS. 7 and 8, by removing the nut 85, the restraint 70 can be removed from the cryopump 10. As a result, by removing the restraint 70, the vibration-proof structure 16 can be released from the restraint 70. When the cryopump 10 is used in the field, that is, when the cryopump 10 is provided in the vacuum processing device and is evacuated, the vibration-proof structure 16 can provide the vibration-proof function.

The present invention has been described above based on the examples. It will be understood by those skilled in the art that the present invention is not limited to the above-described embodiment, and that various modifications are possible, and such modifications are also within the scope of the present invention. Various features described in relation to the certain embodiment are also applicable to other embodiments. A new embodiment resulting from combination has the effects of each of the combined embodiments.

In the above-described embodiment, the case where the vibration-proof structure 16 has the specific configuration, that is, the case where the first annular vibration-proof material 38, the first annular support member 40, the intermediate annular vibration-proof material 42, the second annular support member 44, and the second annular vibration-proof material 46 are disposed in this order from the first flange 28 toward the second flange 30 to configure the annular lamination vibration-proof body 32 is described as the example. However, the restraint 70 according to the embodiment is also applicable to another vibration-proof structure that may be mounted on the cryopump 10. The vibration-proof structure of the cryopump 10 that is combined with the restraint 70 may have a simpler configuration. For example, a vibration-proof material such as vibration-proof rubber may be interposed between the vacuum chamber flange 24 of the cryopump vacuum chamber 12 and the first flange 28 of the cryocooler 14 to fix the two flanges.

Although the present invention has been described using specific terms based on the embodiment, the embodiment only shows one aspect of the principle and application of the invention, and the embodiment allows for many modifications and changes in arrangement without departing from the concept of the invention as defined in the claims.

It should be understood that the invention is not limited to the above-described embodiment, but may be modified into various forms on the basis of the spirit of the invention. Additionally, the modifications are included in the scope of the invention.

What is claimed is:

1. A cryopump comprising:
a cryocooler;
a cryopump vacuum chamber;
a vibration-proof structure that connects the cryocooler to the cryopump vacuum chamber; and
a removable restraint that connects the cryocooler to the cryopump vacuum chamber in parallel to the vibration-proof structure and restrains both of expansion and contraction of the vibration-proof structure between the cryocooler and the cryopump vacuum chamber.

2. The cryopump according to claim 1,
wherein a first attachment portion is formed in the cryopump vacuum chamber or in a first end portion of the vibration-proof structure toward the cryopump vacuum chamber,
a second attachment portion is formed in the cryocooler or in a second end portion of the vibration-proof structure toward the cryocooler, and
the removable restraint includes one end attached to the first attachment portion and another end attached to the second attachment portion.

3. The cryopump according to claim 2,
wherein the cryopump vacuum chamber includes a vacuum chamber flange,
the cryocooler includes a cryocooler flange,
the vibration-proof structure includes a first flange that is fixed to the vacuum chamber flange and a second flange that is fixed to the cryocooler flange,
the first attachment portion is formed in an outer peripheral surface of the vacuum chamber flange or the first flange, and
the second attachment portion is formed in an outer peripheral surface of the cryocooler flange or the second flange.

4. The cryopump according to claim 2,
wherein the cryopump vacuum chamber includes a vacuum chamber flange,
the cryocooler includes a cryocooler flange,
the vibration-proof structure includes a first flange that is fixed to the vacuum chamber flange and a second flange that is fixed to the cryocooler flange,
the first attachment portion is formed in the vacuum chamber flange or the first flange, and
the second attachment portion is formed in the cryocooler flange or the second flange, and
wherein the removable restraint includes:
a first restraint member that includes a first end attached to the first attachment portion and a second end attached to the second attachment portion and that restrains expansion of the vibration-proof structure, and
a second restraint member that is disposed along the first restraint member between the first attachment portion and the second attachment portion and that restrains contraction of the vibration-proof structure.

5. The cryopump according to claim 4,
wherein the first attachment portion includes a first edge portion that is formed in the vacuum chamber flange or the first flange, and
the second attachment portion includes a second edge portion that is formed in the cryocooler flange or the second flange.

6. The cryopump according to claim 1,
wherein the vibration-proof structure includes:
a first flange that is fixed to the cryopump vacuum chamber,
a second flange that is fixed to the cryocooler and is airtightly connected to the first flange, and
an annular laminated vibration-proof body where a first annular vibration-proof material, a first annular support member, an intermediate annular vibration-proof material, a second annular support member, and a second annular vibration-proof material are disposed in this order from the first flange to the second flange,
wherein the second annular support member is fixed to the first flange and the first annular support member is fixed to the second flange such that the first flange and the second annular support member are vibration-isolated from the second flange and the first annular support member.

7. A cryopump comprising:
a cryocooler;
a cryopump vacuum chamber;
a vibration-proof structure that connects the cryocooler to the cryopump vacuum chamber; and
a first attachment portion and a second attachment portion to which a removable restraint that restrains both of expansion and contraction of the vibration-proof structure between the cryocooler and the cryopump vacuum chamber is attachable, wherein
the first attachment portion is formed in the cryopump vacuum chamber or in a first end portion of the vibration-proof structure toward the cryopump vacuum chamber, and
the second attachment portion is formed in the cryocooler or in a second end portion of the vibration-proof structure toward the cryocooler.

8. A method of manufacturing a restraint-attached cryopump, the method comprising:
preparing a cryopump; and
attaching a removable restraint to the cryopump,
wherein the cryopump includes a cryocooler, a cryopump vacuum chamber, and a vibration-proof structure that connects the cryocooler to the cryopump vacuum chamber, and
the removable restraint connects the cryocooler to the cryopump vacuum chamber in parallel to the vibration-proof structure and restrains both of expansion and contraction of the vibration-proof structure between the cryocooler and the cryopump vacuum chamber.

9. A method of using a cryopump, the method comprising:
preparing a cryopump to which a removable restraint is attached; and
removing the removable restraint from the cryopump,
wherein the cryopump includes a cryocooler, a cryopump vacuum chamber, and a vibration-proof structure that connects the cryocooler to the cryopump vacuum chamber, and
the removable restraint connects the cryocooler to the cryopump vacuum chamber in parallel to the vibration-proof structure and restrains both of expansion and contraction of the vibration-proof structure.
